(19) United States
(12) Patent Application Publication
(10) Pub. No.: US 2006/0055512 A1
(43) Pub. Date: Mar. 16, 2006

(54) Method and system for monitoring the movement of people

(75) Inventor: David K.M. Chew, Singapore (SG)

Correspondence Address: CONLEY ROSE, P.C., P. O. BOX 3267, HOUSTON, TX, 77253-3267, US

(73) Assignee: STRATECH SYSTEMS LIMITED, SINGAPORE (CN)

(21) Appl. No.: 10/508,302

(22) PCT Filed: Sep. 10, 2004
(86) PCT No.: PCT/SG04/00291

§ 371 Date: May 3, 2005

(51) Int. Cl. G05B 19/00; G07B 15/00; G06K 9/00

(52) U.S. Cl. 340/5.82; 382/115; 340/5.83; 705/13

(57) ABSTRACT

A method of monitoring the movement of people, comprising: obtaining, at a first point along the movement of people from a public area to a secure area, biometric data of individual people and associated identification data; obtaining, at a second point in the secure area, biometric data of individual people and associated identification data; and comparing identification data obtained at the second point with that obtained at the second point, and, where a match is made, comparing the associated image obtained at the first point with the associated image obtained at the second point for the matched identification data.

### FIELD OF THE INVENTION

The present invention relates broadly to a method and system for monitoring the movement of people, and to a computer readable data storage medium having stored thereon computer code means for instructing a computer to execute a method of monitoring the movement of people

### BACKGROUND

Currently, a passport is the only document used in the identification of passengers travelling in, and out of a country. However prior to reaching the destination, there are chances of foul play, such as impersonation, forging the data and photograph contained in the passport. It is difficult for an immigration officer to verify whether the holder of the passport is indeed the person described in the passport. As long as there is some similarity, an immigration officer allows a passenger to proceed further. As immigration officers browse through numerous passports daily, it is tedious to visually identify whether the holder of the passport is wanted by the law-enforcement authorities. This gives room for fugitives to intrude, escape or proceed further with their objective

Terrorism facing the present world may be tackled with the help of technological advancement in security systems. It is particularly necessary to adapt and enhance security systems to track passenger movements in and out of a country. This would deter fugitives from fleeing a country, as well as prevent free travel of passengers who pose security threats.

Existing methods of verifying the identity of an individual involve an immigration officer who checks the details of passengers manually. This not only results in inefficiency, but also increases security lapses.

There is a need for a method and system that could aid emigration, immigration officers and others in screening and monitoring passengers entering and/or leaving a country.

### SUMMARY OF THE INVENTION

According a first aspect of the invention, there is provided a method of monitoring the movement of people, comprising: obtaining, at a first point along the movement of people from a public area to a secure area, biometric data of individual people and associated identification data; obtaining, at a second point in the secure area, biometric data of individual people and associated identification data; and comparing identification data obtained at the second point with that obtained at the second point, and, where a match is made, comparing the associated image obtained at the first point with the associated image obtained at the second point for the matched identification data.

The method may further comprise storing the biometric data of individual people and associated identification data obtained at the first point and/or the second point.

The first and second points may be located at an airport. The first point may be at a ticket check-in point. The second point may be at an aircraft boarding point.

The above method may further comprise transferring the biometric data of individual people and associated identification data obtained at the first and/or second points to a third point along the movement of people out of the secure area.

The above method may further comprise obtaining, at the third point, biometric data of individual people and associated identification data; comparing identification data obtained at the third point with that in the transferred data, and where a match is made, comparing the associated biometric data in the transferred data, with the associated biometric data obtained at the third point for the matched identification data.

The third point may be located an a disembarkation airport. The third point may be an immigration point.

The above method may further comprise periodically obtaining biometric data of people during their presence in the secure area and comparing images to determine suspect characteristics of any person in the secure area.

The periodically obtaining the biometric data of people may be conducted on an aircraft.

The above method may further comprise transferring the biometric data of individual people and associated identification data obtained at the first and/or second points for comparison with the periodically obtained biometric data of people during their presence in the secure area.

The above method may further comprise transferring at least a portion of the periodically obtained biometric data of people during their presence in the secure area to the or a third point along the movement of people out of the secure area for comparison with biometric data and associated data of people obtained at the third point.

The biometric data may comprise one or more of a group comprising images, finger prints, eye scan data.

According to a second aspect of the invention, there is provided a system for monitoring the movement of people, comprising: a first biometric data collection device for obtaining, at a first point along the movement of people from a public area to a secure area, biometric data of individual people; a first data storage device for storing associated identification data; a second biometric data collection device for obtaining, at a second point in the secure area, biometric data of individual people; a second data storage device for storing associated identification data; and a processor device for comparing identification data stored in the first data storage device with that stored in the second data storage device, and, where a match is made, comparing the associated image obtained by the first biometric data collection device with the associated image obtained by the second biometric data collection device for the matched identification data.

The first and second biometric data collection devices may be located at an airport. The first biometric data collection device may be located at a ticket check-in point. The second biometric data collection device may be located at an aircraft boarding point.

The above system may further comprise a transmitter device for transferring the biometric data of individual people and associated identification data obtained by the first and/or second biometric data collection devices to a third data storage device located at a third point along the movement of people out of the secure area.

The above system may further comprise: a third biometric data collection device located at the third point, for obtaining biometric data of individual people and wherein the third data storage device stores associated identification data; and a second processor device for comparing identification data obtained by the third biometric data collection device with that in the transferred data, and, where a match is made, comparing the associated biometric data in the transferred data, with the associated biometric data obtained by the third biometric data collection device for the matched identification data.

The third biometric data collection device and the third data storage device may be located located at an a disembarkation airport. The third biometric data collection device and the third data collection device may be located at an immigration point.

The above system may further comprise a fourth biometric data collection device for periodically obtaining biometric data of people during their presence in the secure area and to determine suspect characteristics of any person in the secure area.

The fourth biometric data collection device may be located on an aircraft. The or a first transmitter device may transfer the biometric data of individual people and associated identification data obtained at the first and/or second points for comparison with the periodically obtained biometric data of people during their presence in the secure area.

The above system may further comprise a second transmitter device for transferring at least a portion of the periodically obtained biometric data of people during their presence in the secure area to the or a third point along the movement of people out of the secure area for comparison with biometric data and associated data of people obtained at the third point.

The biometric data may comprise one or more of a group comprising images, finger prints, eye scan data.

According to a third aspect of the invention, there is provided a computer readable data storage medium having stored thereon computer code means for instructing a computer to execute a method of monitoring the movement of people, comprising: obtaining, at a first point along the movement of people from a public area to a secure area, biometric data of individual people and associated identification data; obtaining, at a second point in the secure area, biometric data of individual people and associated identification data; and comparing identification data obtained at the second point with that obtained at the second point, and, where a match is made, comparing the associated image obtained at the first point with the associated image obtained at the second point for the matched identification data.

### BRIEF DESCRIPTION OF THE DRAWINGS

Non-limiting embodiments of the invention are herein described with reference to the accompanying drawings, in which:

FIG. 1 is a schematic drawing of an example embodiment of the invention employed in an airport;

FIG. 2 is an exemplary flowchart to illustrate the operation of the example embodiment of FIG. 1; and

FIG. 3 is a schematic drawing illustrating a computer for implementing the method and system in an example embodiment of the invention.

### DETAILED DESCRIPTION

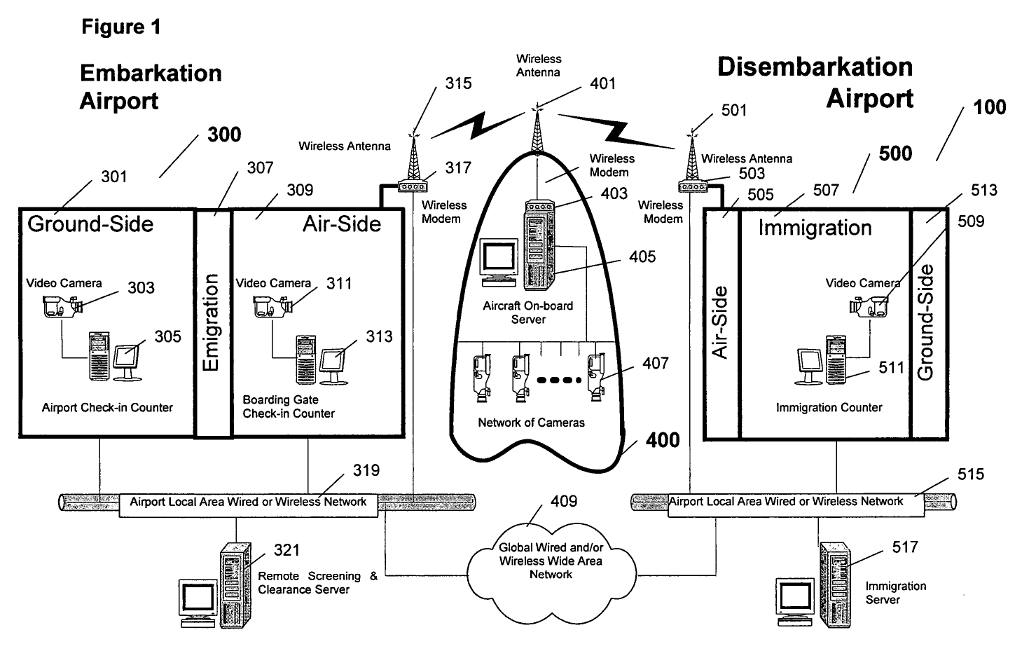

An example embodiment of a security system 100 employed in tracking passengers during air-travel is described in FIG. 1. This is made possible by accurate identification and tracking of passengers. Individuals are identified by using their biometric features, such as facial recognition, fingerprint recognition, retinal/iris recognition etc. Data transfer, in this example embodiment is made through wireless technology. Computer-vision is employed to intelligently track the movements of air travellers.

FIG. 1 illustrates an example embodiment involving an airport security system 100. The system 100 includes an embarkation airport 300, an aircraft 400 and a disembarkation airport 500.

The embarkation airport 300 in the example embodiment comprises three areas, namely a ground-side area 301, an emigration area 307 and an air-side area 309.

The ground-side area 301 refers to the area that can be accessed by the public at a disembarkation airport 300 i.e. the area before the emigration 307. The ground-side area 301 includes a video camera 303 located near an airport check-in or an airline ticketing counter 305. The officials located at the check-in counters 305 checks for formal matters, such as passenger identification, passport validity, visa etc besides issuing a boarding pass. The video camera 303 captures an image of a passenger when he/she checks in at the airport check-in counters 305.

Other than officers from government agencies, the emigration area 307 is restricted to passengers. These officers check details, such as passenger identification, emigration clearance certificate, identification of passengers who are forbidden from travel, identification of fugitives etc.

The air-side area 309 refers to the restricted area meant for passengers i.e. the areas after emigration 307. The air-side area 309 includes a video camera 311 located near the boarding gate check-in counter. The video camera 311 captures the image (for verification) of the passenger before boarding the aircraft 400.

The security systems of both the ground-side area 301 and air-side area 309 of a disembarkation airport 300 are linked to each other through a local area wired or wireless network 319 and a remote screening and clearance server 321.

A wireless antenna 315 is installed proximate to the air-side area 309 for transmitting passenger data to a respective aircraft 400 (at radio frequencies) through a wireless modem 317. Similarly, the passenger data from the aircraft 400 can also be received by the antenna 315 for processing.

The passenger data transmitted by the antenna 315 are received by an antenna 401 and a wireless modem 403 in the aircraft 400. The data received at the modem 403 are processed at the aircraft on-board server 405. On-board cameras 407 are placed inside the aircraft for obtaining images of passenger onboard the aircraft. The images from these cameras are also directed to the onboard server 405 for processing. In an example embodiment, an onboard camera 407 may be mounted above each passenger and are monitored periodically for correct matching. Alternatively, the onboard camera 407 may also be mounted beside or integral with the LCD TV monitor meant for each passenger.

The disembarkation airport 500 in the example embodiment comprises three areas, namely a ground-side area 513, an immigration area 507 and an air-side area 505.

The ground-side area 513 refers to the area that can be accessed by the public in a disembarkation airport 500. i.e. the area after the immigration 507.

The Immigration area 507 includes a video camera 509 located near the immigration counter 511. The video camera 509 captures an image of a passenger when he/she arrives at a disembarkation airport 500. Immigration officers check the details of the passenger, such as passenger identification, visa, identification of passengers who are forbidden from travel, identification of fugitives etc.

The air-side area 505 is restricted only to passengers who arrive to disembark at an airport 500.

A wireless antenna 501 is installed proximate to the air-side area 505 for receiving passenger data from a respective aircraft 400 (at radio frequencies) through a wireless modem 503. Similarly, the passenger data can also be transmitted by the antenna 501 to the aircraft 400 for processing.

The passenger data received through the antenna 501 and through the wireless modem 503 are routed through a local area wired or wireless network to an immigration server 515 at the disembarkation airport 500 for processing of the data.

The local area network 319 at the embarkation airport 300 and the local area network 515 at the disembarkation airport 500 are linked to each other by global wired or wireless wide area network 409.

The image of a passenger taken by the video camera 303 when he/she checks in at an airport check-in counter 305 may be processed in the following ways:
1. The image is verified with the existing database of individuals wanted by law enforcement authorities to ensure that a passenger is not one among them. In case of inconsistencies, the staff at the airport check-in counter 305 alerts the airport security, police or emigration 307 immediately.
2. The image is optionally sent to a disembarkation airport 500 and/or any other authorities to identify the passenger by matching his/her image with the images of those individuals wanted; and
3. The image is stored in the airport database for future reference. The staff at the airport check-in counter 305 keys in, scans in or enters data of the passenger, such as his/her passport photograph and/or passport details. This data together with the photo of the passenger captured by the video camera 303 are stored in the remote screening and clearance server 321 of the embarkation airport 300.

At the air side area 309 of the embarkation airport 300, another video camera 311 located near the boarding gate check-in counter, captures the photograph of the passenger. The passenger's photograph is attached with his/her passport details and sent to the server 321 of the embarkation airport 300 wherein the photograph taken at the boarding gate check-in counter 313 is compared with that of the earlier photograph taken at the Check-in counter 305. This ensures that the passenger who is boarding the aircraft is the same as the one who checked in earlier at the airport Check-in counter 305.

Real-time passenger data stored in the server 321 is wirelessly transmitted to a server on the aircraft 405 (“Aircraft On-Board Server”).

While a passenger is seated in the aircraft 400 before take-off and during the journey, cameras 407 that are installed in front of each passenger repeatedly takes photographs of the passenger. This helps in monitoring and tracking passenger movements. Repeated images of passengers are also used to enable the computer 405 to select the best picture of a passenger, which is stored in passenger database of the air-craft server 405. The enhanced images of passengers can be used to identify passengers more accurately and safely. The passenger data stored in the aircraft server 405 is matched with the data of the passenger at the remote screening server 321. In case of discrepancies, the security personnel at the embarkation airport 300, onboard the aircraft 400, or at the disembarkation airport 500 are alerted for necessary action.

The photographs captured by the cameras 407 onboard an aircraft 400 may also be used to identify suspicious behaviour of passengers inside the aircraft 400. Suspicious behaviour includes, but is not limited to, fidgeting movements, excess of sweat, nervous signs, such as constant tightening of muscles and abnormal/continuous eye movement of a passenger. However, caution must be exercised to avoid identifying a passenger as a suspicious character merely because he/she has a fear of flying.

During the journey, images of passengers onboard the aircraft can also be wirelessly transmitted to the immigration server 517 of the disembarkation airport 500 to enable the officials in the immigration to identify a person wanted by that country.

Before the aircraft reaches the destination, immigration officers would have already received and studied the passengers data. Therefore, it is easier to identify persons who need further attention/questioning or to even apprehend passengers who are in the wanted list. In addition, the images of passengers taken by the cameras 509 located by the immigration 507 may be processed to identify if a passenger arriving at the point of disembarkation is the same person the one who embarked or boarded at the embarkation airport 300. The passport data would also be cross-checked to ensure that it is same as the one used at the embarkation airport without any tampering.

The photographs of passengers stored in the embarkation server 321 and disembarkation server 517 may also be retrieved and referred to when the passenger makes his/her next journey in future.

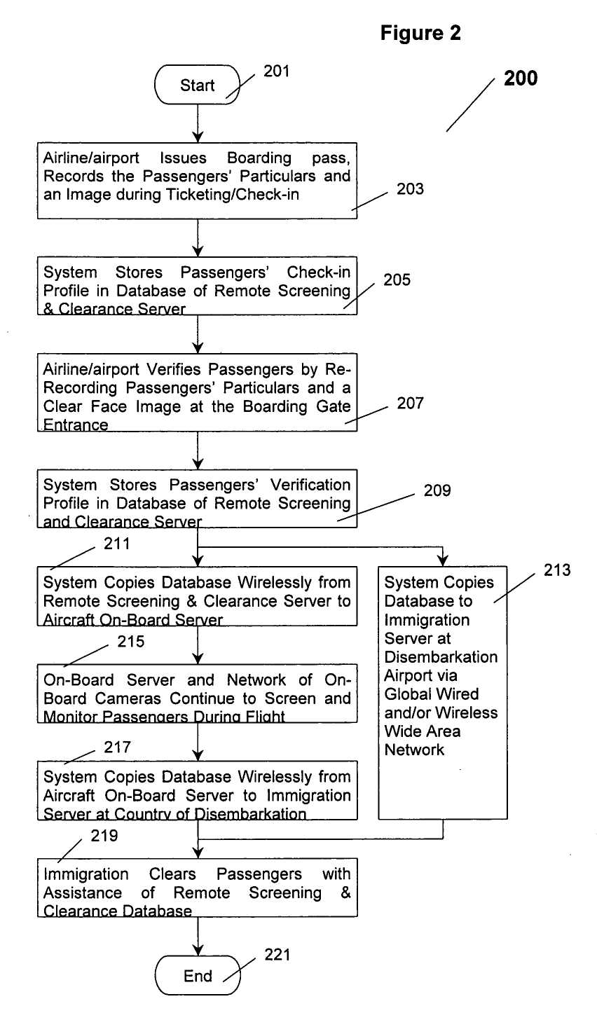

FIG. 2 illustrates an exemplified process flow of an example embodiment of an airport security system 100 shown in FIG. 1.

The process flow starts at step 201. At step 203, an airline/airport staff at the ticketing/check-in counter issues boarding pass, records the passengers' profile and passenger's image.

At step 205, the passengers' check-in profile is stored in the database of remote screening and clearance server of the embarkation airport.

At step 207, airline/airport staff verifies passengers and re-records passengers' particulars with a clear image at the boarding gate check-in counter to form passengers' verification profile

At step 209, the passengers' verification profiles are stored in database of a remote screening and clearance server.

At step 213, the database containing passengers' verification profile is copied to the immigration server of the disembarkation airport via global wired and/or wireless wide area network.

At step 211, the database (containing passenger's verification profile) from remote screening and clearance server is transmitted wirelessly and copied to aircraft on-board server.

At step 215, the on-board server and the network of on-board cameras repeatedly screen and monitor passengers during the journey.

At step 217, the database containing passengers' data from the aircraft on-board-server is transmitted wirelessly to the immigration server and a copy of the data is stored at the immigration server at the country of disembarkation.

At step 219, the officers at the immigration clears passengers once the passengers' records at the airport of embarkation as well as the airport of disembarkation tallies and the disembarking passenger is not wanted by any authorities at the airport of disembarkation.

The security system in the example embodiment employs biometrics and intelligent technologies to assist an immigration officer in identifying a suspect. The system alerts the relevant authorities when passengers behave suspiciously, for further observation and necessary action. Intelligent technology may be used to analyse the behavior and actions of passengers.

The security system described in the example embodiment has many applications in air travel. It may be used in monitoring air travelers and ensures that the passenger who checks-in, the passenger who is seated in the aircraft and the passenger who checks out at the point of arrival are the same. This is achieved in the example embodiment by capturing the images of passengers (by a video camera) at the ticketing/check-in counter, boarding gates, aircraft, immigration and processing the images against the passport/profile of a passenger. Additionally, the repeated images of passengers taken on-board the aircraft are compared to check if there is any mismatch in the appearance of the passengers or is any one behaving suspiciously. Further, the system also assists in screening people who are wanted by law enforcement authorities or those passengers banned from entering or exiting. The system can also detect and alert if a a checked-in passenger is found missing and he/she does not turn up at the boarding gate or at the point of arrival.

Embodiments of the present invention may utilise the following technologies:
1. For recognition of individual, biometrics technology, such as but not limited to facial recognition, finger print recognition, retinal/iris recognition etc. is employed.
2. Wireless technology for the purposes of data transmission.
3. Computer vision based technology for object tracking.
4. Server, software and database for storage of passenger data in an aircraft
5. Server, software and database for storage of passenger data in the airports
6. Appropriate on-board airline computer, interfaces and software in an aircraft
7. Cameras at ticketing/check-in/boarding/immigration counters.

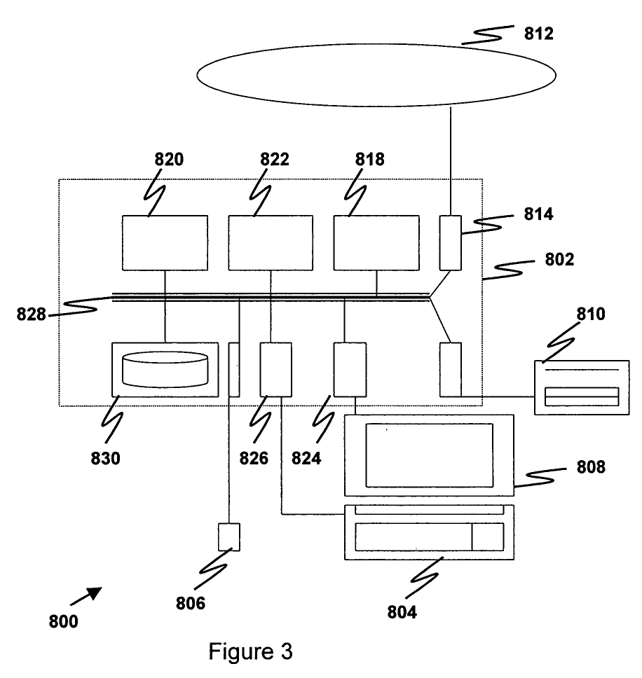

The method and system of the example embodiment can be implemented on a computer system 800, schematically shown in FIG. 3. It may be implemented as software, such as a computer program being executed within the computer system 800, and instructing the computer system 800 to conduct the method of the example embodiment.

The computer system 800 comprises a computer module 802, input modules such as a keyboard 804 and mouse 806 and a plurality of output devices such as a display 808, and printer 810.

The computer module 802 is connected to a computer network 812 via a suitable transceiver device 814, to enable access to e.g. the Internet or other network systems such as Local Area Network (LAN) or Wide Area Network (WAN).

The computer module 802 in the example includes a processor 818, a Random Access Memory (RAM) 820 and a Read Only Memory (ROM) 822. The computer module 802 also includes a number of Input/Output (I/O) interfaces, for example I/O interface 824 to the display 808, and I/O interface 826 to the keyboard 804.

The components of the computer module 802 typically communicate via an interconnected bus 828 and in a manner known to the person skilled in the relevant art.

The application program is typically supplied to the user of the computer system 800 encoded on a data storage medium such as a CD-ROM or floppy disk and read utilising a corresponding data storage medium drive of a data storage device 830. The application program is read and controlled in its execution by the processor 818. Intermediate storage of program data maybe accomplished using RAM 820.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

The number of stages wherein a passenger identification is made may be increased. Additional cameras may be mounted in emigration area 307 and air side area 505.

In the example embodiment, identification of a passenger is achieved by comparing the photographs of passengers using a facial recognition software. Alternatively, other identification methods, such as finger print recognition and/or retinal/iris scanning technology may also be used.

Embodiments of the invention may also aid security personnel, emigration and immigration officers, airline staff and others to identify potentially dangerous persons entering or leaving a building, venue, area or country or on board an aircraft or any other mode of transportation, by making passenger information available to them in real-time, for instance before departure and upon arrival.

Embodiments of the invention may speed up customs clearance and hence the efficiency. The system may also assist to increase the level of accuracy in passenger identity. They may even lead to a quicker “greenlane effect”, whereby travelers clear customs quickly without compromising on security.

Embodiment of the invention may help to increase the level of security at the airport as it provides physical matching, instead of mere information matching. The system ensures that a person holding a passport is the same that is boarding the aircraft.

Embodiments of the invention may also be applied to sea travel, train travel etc. In the case of train travel, initial checking may be done at ticketing counter and identification of passengers may be made at the platform entrance or train entrance. In such cases, passengers may be identified by identification card or by biometrics data, such as iris scan. The invention may also be applied to issuing entry tickets to venues, such as sports complex, or in any event where identification is required.

Embodiment of the invention may be used even when the tickets are purchased over the Internet. At the time of purchase, the purchaser provides a photograph and data, such as identity card, passport data, which is compared the photographs of those who are wanted by the law enforcement authorities. When a person with an entry ticket enters an airport, stadium etc identification details are checked at the point of entry. In case there is a change in the physical appearance of the person, or if the person is wanted by law enforcement authorities, the system alerts the security personnel to take the necessary action.

1. A method of monitoring the movement of people, comprising:
obtaining, at a first point along the movement of people from a public area to a secure area, biometric data of individual people and associated identification data;
obtaining, at a second point in the secure area, biometric data of individual people and associated identification data; and
comparing identification data obtained at the second point with that obtained at the second point, and, where a match is made, comparing the associated image obtained at the first point with the associated image obtained at the second point for the matched identification data.

2. A method according to claim 1, further comprising storing the biometric data of individual people and associated identification data obtained at the first point and/or the second point.

3. A method according to claim 1, wherein the first and second points are located at an airport.

4. A method according to claim 1, wherein the first point is at a ticket check-in point.

5. A method according to claim 1, wherein the second point is at an aircraft boarding point.

6. A method according to claim 1, further comprising transferring the biometric data of individual people and associated identification data obtained at the first and/or second points to a third point along the movement of people out of the secure area.

7. A method according to claim 6, further comprising:
obtaining, at the third point, biometric data of individual people and associated identification data;
comparing identification data obtained at the third point with that in the transferred data, and, where a match is made, comparing the associated biometric data in the transferred data, with the associated biometric data obtained at the third point for the matched identification data.

8. A method according to claim 6, wherein the third point is located an a disembarkation airport.

9. A method according to claim 6, wherein the third point is an immigration point.

10. A method according to claim 1, further comprising periodically obtaining biometric data of people during their presence in the secure area and comparing images: to determine suspect characteristics of any person in the secure area.

11. A method as claimed in claim 10, wherein the periodically obtaining the biometric data of people is conducted on an aircraft.

12. A method according to claim 10, further comprising transferring the biometric data of individual people and associated identification data obtained at the first and/or second points for comparison with the periodically obtained biometric data of people during their presence in the secure area.

13. A method according to claim 10, further comprising transferring at least a portion of the periodically obtained biometric data of people during their presence in the secure area to the or a third point along the movement of people out of the secure area for comparison with biometric data and associated data of people obtained at the third point.

14. A method according to claim 1, wherein said biometric data comprises one or more of a group comprising images, finger prints, eye scan data.

15. A system for monitoring the movement of people, comprising:
a first biometric data collection device for obtaining, at a first point along the movement of people from a public area to a secure area, biometric data of individual people
a first data storage device for storing associated identification data;
a second biometric data collection device for obtaining, at a second point in the secure area, biometric data of individual people;
a second data storage device for storing associated identification data; and
a processor device for comparing identification data stored in the first data storage device with that stored in the second data storage device, and, where a match is made, comparing the associated image obtained by the first biometric data collection device with the associated image obtained by the second biometric data collection device for the matched identification data.

16. A system according to claim 15, wherein the first and second biometric data collection devices are located at an airport.

17. A system according to claim 15, wherein the first biometric data collection device is located at a ticket check-in point.

18. A system according to claim 15, wherein the second biometric data collection device is located at an aircraft boarding point.

19. A system according to claim 15, further comprising a transmitter device for transferring the biometric data of individual people and associated identification data obtained by the first and/or second biometric data collection devices to a third data storage device located at a third point along the movement of people out of the secure area.

20. A system according to claim 19, further comprising:
a third biometric data collection device located at the third point, for obtaining biometric data of individual people and wherein the third data storage device stores associated identification data;
and a second processor device for comparing identification data obtained by the third biometric data collection device with that in the transferred data, and, where a match is made, comparing the associated biometric data in the transferred data, with the associated biometric data obtained by the third biometric data collection device for the matched identification data.

21. A system according to claim 19, wherein the third biometric data collection device and the third data storage device are located at a disembarkation airport.

22. A system according to claim 19, wherein the third biometric data collection device and the third data collection device are located at an immigration point.

23. A system according to claim 15, further comprising a fourth biometric data collection device for periodically obtaining biometric data of people during their presence in the secure area and to determine suspect characteristics of any person in the secure area.

24. A system as claimed in claim 23, wherein the fourth biometric data collection device is located on an aircraft.

25. A system according to claim 23, wherein the or a first transmitter device transferrs the biometric data of individual people and associated identification data obtained at the first and/or second points for comparison with the periodically obtained biometric data of people during their presence in the secure area.

26. A system according to claim 23, further comprising a second transmitter device for transferring at least a portion of the periodically obtained biometric data of people during their presence in the secure area to the or a third point along the movement of people out of the secure area for comparison with biometric data and associated data of people obtained at the third point.

27. A system according to claim 15, wherein said biometric data comprises one or more of a group comprising images, finger prints, eye scan data.

28. A computer readable data storage medium having stored thereon computer code means for instructing a computer to execute a method of monitoring the movement of people, comprising:
obtaining, at a first point along the movement of people from a public area to a secure area, biometric data of individual people and associated identification data;
obtaining, at a second point in the secure area, biometric data of individual people and associated identification data; and
comparing identification data obtained at the second point with that obtained at the second point, and, where a match is made, comparing the associated image obtained at the first point with the associated image obtained at the second point for the matched identification data.
